(19) United States
(12) Patent Application Publication
(10) Pub. No.: US 2011/0001878 A1
(43) Pub. Date: Jan. 6, 2011

(54) EXTRACTING GEOGRAPHIC INFORMATION FROM TV SIGNAL TO SUPERIMPOSE MAP ON IMAGE

(75) Inventors: Libiao Jiang, San Diego, CA (US); Yang Yu, San Diego, CA (US)

Correspondence Address: ROGITZ & ASSOCIATES, 750 B STREET, SUITE 3120, SAN DIEGO, CA, 92101, US

(73) Assignees: SONY CORPORATION; SONY ELECTRONICS INC.

(21) Appl. No.: 12/497,139

(22) Filed: Jul. 2, 2009

(51) Int. Cl. H04N 5/45; G06K 9/72; G10L 21/00

(52) U.S. Cl. 348/565; 382/229; 704/270.1; 348/E05.112; 704/E21.019

(57) ABSTRACT

A TV uses optical character recognition (OCR) to extract text from a TV image and/or voice recognition to extract text from the TV audio and if a geographic place name is recognized, displays a relevant map in a picture-in-picture window on the TV. The user may be given the option of turning the map feature on and off, defining how long the map is displayed, and defining the scale of the map to be displayed.

### I. FIELD OF THE INVENTION

The present invention relates generally to extracting geographic information from TV images using optical character recognition (OCR) or from audio to superimpose a relevant map on the image.

### II. BACKGROUND OF THE INVENTION

Present principles understand that when viewing a TV show of a scene, e.g., a news show reporting a fire or an ongoing police chase, a viewer may wish to know where the event is occurring apart from a verbal report by the TV reporter. As also understood herein, merely extracting geographic information from a TV image as it is being recorded is insufficient to satisfy the viewer'S real-time curiosity.

Furthermore, present principles understand that simply obtaining a map image that might be related to a TV show likewise impedes a viewer's understanding derived from a visual representation of the event location if the map is displayed in an inconvenient manner.

### SUMMARY OF THE INVENTION

A TV system includes a TV display, a processor controlling the TV display to present TV images, and one or more audio speakers which are caused by the processor to present audio associated with the TV images. A computer-readable medium is accessible to the processor and bears instructions to cause the processor to extract text information from the audio and/or images. The instructions also cause the processor to determine whether the text information represents a geographic place name, and if the text information represents a geographic place name, to present a map of a geographic place corresponding to the geographic place name in a picture-in-picture window on the TV display.

In some embodiments the processor can receive user input indicating whether maps should be presented during operation. If the user input indicates maps are to be presented the processor can prompt the user to enter a desired time period defining how long a map is presented on the TV display. The processor then presents maps on the TV display for time periods conforming to a user-entered desired time period. Similarly, if the user input indicates maps are to be presented, the processor can prompt the user to enter a desired map scale and then present maps on the TV display conforming to the desired map scale. If desired, the processor may extract text information from both the audio and images and only if text from the audio representing a geographic place name matches text in the video, present a corresponding map.

In another aspect, a TV system includes a TV display, a processor controlling the TV display to present TV images, and one or more audio speakers which are caused by the processor to present audio associated with the TV images. A computer-readable medium is accessible to the processor avid bears instructions to cause the processor to receive user input indicating whether a map feature is to be enabled and only if the user input indicates that the map feature is to be enabled, to extract text information from the audio and/or images. The processor correlates the text information to a map of a geographic place corresponding to the text information.

In yet another aspect, a TV processor executes a method that includes receiving a TV signal, presenting the TV signal on a TV display and at least one TV speaker, and analyzing the TV signal for geographic words. In response to detecting a geographic word, the method executed by the processor includes presenting on the TV display, along with the TV signal and in real time without first recording the TV signal, an image of a map showing the geographic location indicated by the geographic word.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of an example TV in accordance with present principles, showing an example set-up user interface on screen;

FIG. 2 is a flow chart of example set-up logic;

FIG. 3 is a flow chart of example operating logic;

FIG. 4 is a screen shot of an example picture-in-picture map overlaid on a main TV image; and

FIG. 5 is a flow chart of example alternate operating logic.

### DETAILED DESCRIPTION OF THE PREFERRED EMBODIMENT

Referring initially to FIG. 1, a TV system 10 includes a TV chassis 12 holding a TV display 14. The display presents TV signals received through a TV tuner 16 from a source 18 of TV signals such as a terrestrial antenna, cable connection, satellite receiver, etc. under control of a processor 20. The processor 20 also causes audio in the TV signals to be presented on one or more speakers 22. It is to be understood that while the components of FIG. 1 are shown housed in the chassis 12, in some embodiments some of the components, e.g., a tuner and/or processor, may be housed separately in a set-top box and can communicate with components inside the chassis.

The processor 20 can access one or more computer-readable media 24 such as solid state storages, disk storages, etc. The media 24 may include instructions executable by the processor 20 to undertake the logic disclosed below. Also, the media 24 may store map information. In addition or alternatively the TV system 10 may include a computer interface 26 such as but not limited to a modem or a local area network (LAN) connection such as an Ethernet interface that establishes communication with a wide area network 28, and map information can be downloaded from one or more servers on the WAN 28 in real time on as needed-basis.

To support the below-described text extraction from audio, a microphone 30 may be provided and may be in communication with the processor 20. The processor alternatively may process the received electrical signal representing the audio without need for a microphone. Also, a wireless command signal receiver 32 such as an RF or infrared receiver can receive user input from, e.g., a remote control 34 and send the user input to the processor 20.

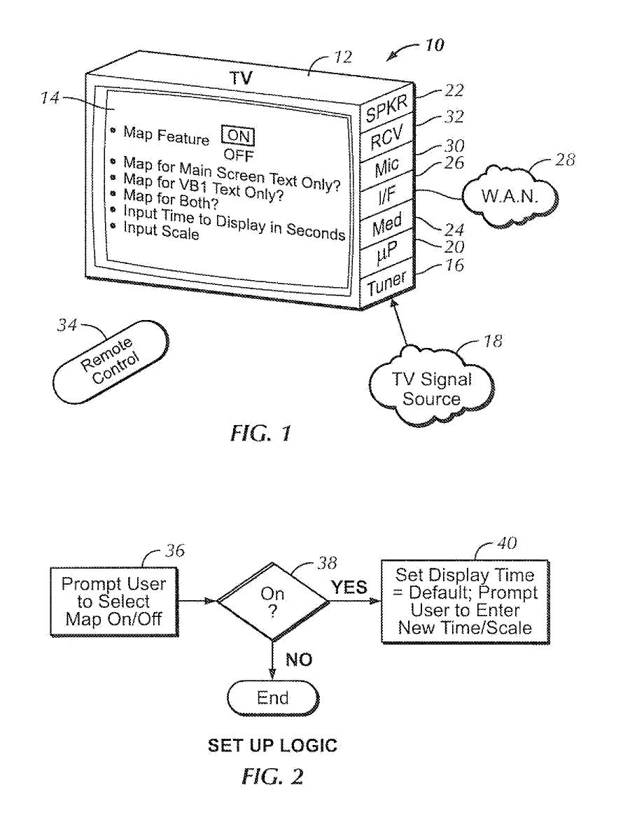

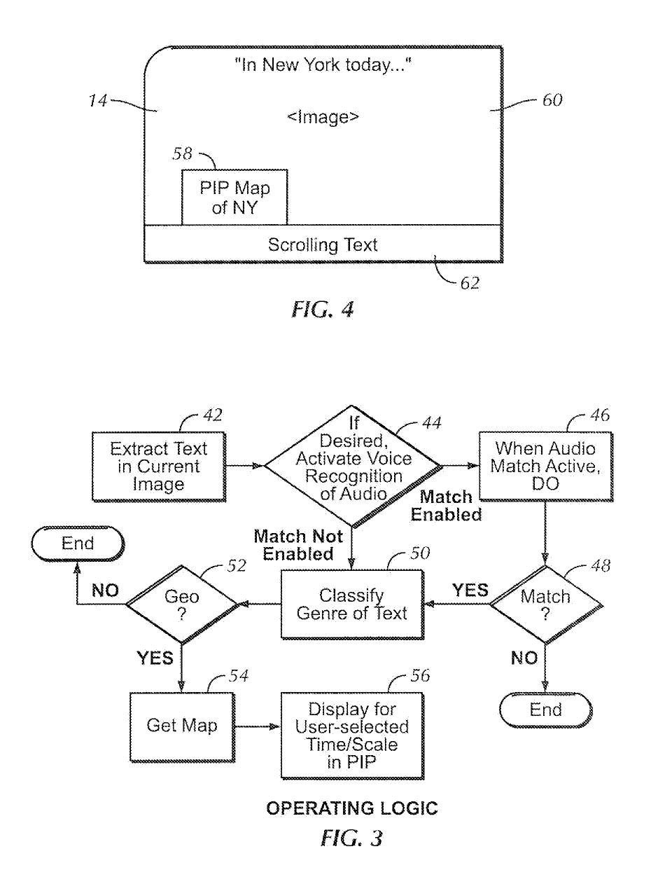

Cross-referencing FIGS. 1 and 2, in some example embodiments the map generation features may be turned on and off as desired by the user. Accordingly, at block 36 in FIG. 2, using a TV setup menu or initial menu the processor 20 can prompt the user to input a signal indicating whether the user wants to activate the map feature. Such a prompt is shown in FIG. 1, with the box around “on” indicating that the user has selected (by, e.g., manipulating the remote control 34) to activate the map feature. When this occurs, the test at decision diamond 38 in FIG. 2 is positive, so in non-limiting implementations the logic flows to block 40 if desired to allow the user to define certain map presentation parameters. For example, as indicated in block 40 the user can select the time period a map is to be displayed in the logic of FIGS. 3 and 5 below, after which the map is removed from view. This may be done by allowing the user to manipulate the remote control 34 to input a desired number of seconds or by presenting a drop-done menu with a series of predefined time selections, e.g., “10 seconds”, “20 seconds”, etc. from which the user can select a period. As indicated at block 40, a default displays time period can be established until such time as the user changes to another, more desired (by the user) period.

The user may also be given the opportunity to select a desired map scale. For example, the user can be given the opportunity to input a textual scale designation (e.g., “neighborhood”, “city”, “county”, “region”, “state”, etc.) Or, a drop-down menu with predefined scales can be presented from which the user can select a desired scale.

These selections are shown on the example user interface of FIG. 1. As also indicated in FIG. 1, the user may given the choice of activating the below-described map feature based on text in the main screen image only, or based only on text in a scrolling banner at the bottom of, e.g., a typical news show that might be carried in the vertical blanking interval (VBI), or based on both. In this way, a user who might not wish to activate map presentation based on text in a scrolling banner, which may not have anything to do with the subject of the currently displayed image, can so select. Or, a user who wishes to have maps displayed only for geographic subject matter in the scrolling banner may also so select.

Now referring to FIG. 3, assuming the user has activated the map feature, at block 42 text is extracted from content in the image in the user-selected screen portion or portions (e.g., main screen only, scrolling banner only, both). This extraction can be done using an optical character recognition (OCR) engine stored, for example, on the medium 24 and executed by the processor 20.

As recognized herein, it may be desirable to limit map display to only geographic place names that appear on both the image and in the audio of the TV signal, underscoring the importance of the particular place name. If this is determined to be the case as represented by decision diamond 44, the logic flows to block 46 to enter a DO loop when the match feature is active. At block 48, it is determined for text in the image whether the same word is in the accompanying audio. To this end, the output of the microphone 30 shown in FIG. 1 can be digitized and analyzed by the processor 20 executing a word recognition engine that can be stored on the medium 24. Or, the processor may simply process the received TV signal representing the audio without need for using a microphone to detect the audible format of the signal. In any case, only if a match is found when this feature is activated does the logic proceed to block 50. If the matching feature is not activated the logic moves from decision diamond 44 to block 50.

At optional block 50, the logic classifies text extracted at block 42 into genres using classification engine techniques. For example, an index of geographic place names may be stored in the medium 24 or accessed on the WAN 28 and if text matches an entry in the index it is classified as “geographic”. In addition or alternatively if text contains geo-centric terms such as “lake”, “township”, “burg”, “street”, it may be classified as geographic.

If the text is determined to be a geographic place name at decision diamond 52, the logic moves to block 54 to obtain a computer-stored map of the place name. The map may be accessed from a map database in the medium 24 and/or downloaded from the WAN 28 through the network interface 28.

Proceeding to block 56, the map obtained at block 54 is presented on the TV display 14 for the user-selected time duration and at the user-selected scale. To this end, the processor 20 scales the map according to the user selection, if enabled.

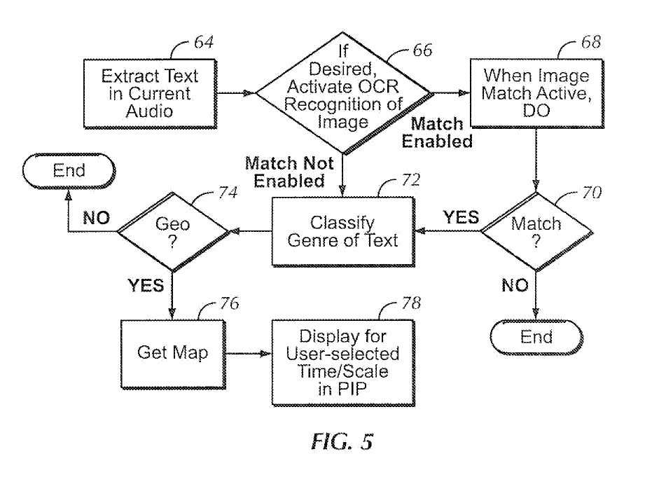

Referring briefly to FIG. 4, in a preferred embodiment the map is displayed in a picture-in-picture window 58 that is overlaid on the main image 60 which is presented on the TV display 14. Accordingly, the map is displayed substantially simultaneously with the image bearing the geographic place name that is the subject of the map. In the non-limiting example embodiment shown the PIP map window 58 is presented near the bottom of the main image just above a sideways-scrolling banner 62. In another embodiment the main image may be removed from view momentarily, e.g., five seconds and the map presented full-screen on the TV display 14, after which period the map disappears and the TV image resumes.

Instead of using OCR to extract text from the TV image for map selection, present principles may apply to using voice recognition to extract words from the audio for map selection. Such an embodiment is shown in FIG. 5. Assuming the user has activated the map feature, at block 64 text is extracted from content in the audio. This extraction can be done using a voice recognition engine stored, for example, on the medium 24 and executed by the processor 20.

As recognized herein, it may be desirable to limit map display to only geographic place names that appear on both the image and in the audio of the TV signal, underscoring the importance of the particular place name. If this is determined to be the case as represented by decision diamond 66, the logic flows to block 68 to enter a DO loop when the match feature is active. At block 70, it is determined for text extracted from the audio whether the same word is in the accompanying image. To this end, the processor 20 can execute an OCR engine that can be stored on the medium 24. Only if a match is found when this feature is activated does the logic proceed to block 72. If the matching feature is not activated the logic moves from decision diamond 66 to block 72.

At optional block 72, the logic classifies text extracted at block 64 into genres using classification engine techniques. For example, an index of geographic place names may be stored in the medium 24 or accessed on the WAN 28 and if text matches an entry in the index it is classified as “geographic”. In addition or alternatively if text contains geo-centric terms such as “lake”, “township”, “burg”, “street”, it may be classified as geographic.

If the text is determined to be a geographic place name at decision diamond 74, the logic moves to block 76 to obtain a computer-stored map of the place name. The map may be accessed from a map database in the medium 24 and/or downloaded from the WAN 28 through the network interface 28.

Proceeding to block 78, the map obtained at block 76 is presented on the TV display 14 for the user-selected time duration and at the user-selected scale. To this end, the processor 20 scales the map according to the user selection, if enabled.

While the particular EXTRACTING GEOGRAPHIC INFORMATION FROM TV SIGNAL TO SUPERIMPOSE MAP ON IMAGE is herein shown and described in detail, it is to be understood that the subject matter which is encompassed by the present invention is limited only by the claims.

What is claimed is:

1. A TV system comprising:
at least one TV display;
at least one processor controlling the TV display to present TV images;
at least one audio speaker, the processor causing the speaker to present audio associated with the TV images;
at least one computer-readable medium accessible to the processor and bearing instructions to cause the processor to:
extract text information from the audio and/or images;
determine whether the text information represents a geographic place name;
if the text information represents a geographic place name, present a map of a geographic place corresponding to the geographic place name in a picture-in-picture window on the TV display.

2. The TV system of claim 1, wherein the processor receives user input indicating whether maps should be presented during operation.

3. The TV system of claim 2, wherein if the user input indicates maps are to be presented the processor prompts the user to enter a desired time period defining how long a map is presented on the TV display.

4. The TV system of claim 3, wherein the processor presents maps on the TV display for time periods conforming to a user-entered desired time period.

5. The TV system of claim 2, wherein if the user input indicates maps are to be presented the processor prompts the user to enter a desired map scale.

6. The TV system of claim 5, wherein the processor presents maps on the TV display conforming to the desired map scale.

7. The TV system of claim 1, wherein the processor extracts text information from both the audio and images and only if text from the audio representing a geographic place name matches text in the video, presents a corresponding map.

8. TV, system comprising:
at least one TV display;
at least one processor controlling the TV display to present TV images;
at least one audio speaker, the processor causing the speaker to present audio associated with the TV images;
at least one computer-readable medium accessible to the processor and bearing instructions to cause the processor to:
receive user input indicating whether a map feature is to be enabled;
only if the user input indicates that the map feature is to be enable, extract text information from the audio and/or images and correlate the text information to a map of a geographic place corresponding to the text information.

9. The TV system of claim 8, wherein the processor presents the map in a picture-in-picture window overlaid on a main image.

10. The TV system of claim 8, wherein if the user input indicates the map feature is to be enabled the processor prompts the user to enter a desired time period defining how long a map is presented on the TV display.

11. The TV system of claim 10, wherein the processor presents maps on the TV display for time periods conforming to a user-entered desired time period.

12. The TV system of claim 8, wherein if the user input indicates the map feature is to be enabled the processor prompts the user to enter a desired map scale.

13. The TV system of claim 12, wherein the processor presents maps on the TV display conforming to the desired map scale.

14. The TV system of claim 8, wherein the processor extracts text information from both the audio and images and only if text from the audio representing a geographic place name matches text in the video, presents a corresponding map.

15. TV processor executing a method comprising:
receiving a TV signal;
presenting the TV signal on a TV display and at least one TV speaker;
analyzing the TV signal for geographic words;
in response to detecting a geographic word, presenting on the TV display along with the TV signal and in real time without first recording the TV signal an image of a map showing the geographic location indicated by the geographic word.

16. The TV processor of claim 15, wherein video in the TV signal is analyzed for the geographic words.

17. The TV processor of claim 15, wherein audio in the TV signal is analyzed for the geographic words.

18. The TV processor of claim 15, wherein the processor executes the analyzing act only if a user input signal indicates that a map feature is to be enabled.

19. The TV processor of claim 15, wherein the processor presents the map on the TV display for a user-selected time period, and then removes the map from the display.

20. The TV processor of claim 15, wherein the processor presents the map on the TV in a user-selected scale.
